(19) United States
(12) Patent Application Publication
(10) Pub. No.: US 2007/0179682 A1
(43) Pub. Date: Aug. 2, 2007

(54) Sensitive locking control device for vehicle

(75) Inventors: Sheng-Fu Hu, Miaoli City (TW); Syun-Dao Jhuo, Guanyin Hsiang (TW); Chung-Wen Chou, Longtan Hsiang (TW)

Correspondence Address: BACON & THOMAS, PLLC, 625 SLATERS LANE, FOURTH FLOOR, ALEXANDRIA, VA, 22314, US

(73) Assignee: TUNG THIH ENTERPRISE CO., LTD., Taoyuan Hsien (TW)

(21) Appl. No.: 11/340,639

(22) Filed: Jan. 27, 2006

(51) Int. Cl. G06F 17/00

(52) U.S. Cl. 701/1

(57) ABSTRACT

A sensitive locking control device for a vehicle has a server mounted in the vehicle and a portable proximity controller. The server continuously emits a detecting signal trying to detect whether the proximity controller is within an effective range of the server. When the proximity controller responds to the server by sending a confirmation signal, the server is unable to automatically lock or unlock a vehicle door or a trunk lid without using a key, or to enable or disable a vehicle security system.

### BACKGROUND OF THE INVENTION

1. Field of the Invention

The present invention relates to a sensitive locking control device for vehicle, and more particularly to a locking control device that allows a driver to lock or unlock a door of the vehicle without using a key.

2. Description of the Related Art

Instead of using a key, the remote locking control apparatus for vehicle has already used to unlock or lock a door of the vehicle. Such a remote locking control apparatus includes a server mounted in the vehicle to receive wireless signals output by a portable remote controller. Using the portable remote controller, a driver can simply lock or unlock the vehicle door or the back cover.

The foregoing lucking or unlocking actions for the vehicle door require the driver to actually press operating buttons on the remote controller. However, such a remote controller is still inconvenient for the user because the driver may unintentionally press the operating buttons to cause undesired actions.

Therefore, to avoid the drawbacks of the prior art, the present invention provides a remote sensitive lock control device for vehicle to mitigate and obviate the aforementioned problems.

### SUMMARY OF THE INVENTION

An objective of the present invention is to provide a method for automatically installing cell phone-required software in a target device when the cell phone, at first time, connects to the target device. The installed software may include a driver for the cell phone and application software. The target device can be a computer.

To achieve the objective, the method comprises the steps of connecting a cell phone to a target device; detecting whether or not an application software for the cell phone has been installed in the target device; and automatically executing a program stored in the cell phone by the target device to install the application software for the cell phone in the target device if the application software does not existed in the target device.

The features of the present invention will be more clearly understood when taken in conjunction with the accompanying drawings.

### BRIEF DESCRIPTION OF THE DRAWINGS

FIG. 1 is a block diagram of a server in accordance with the present invention;

FIGS. 2A-2J show a circuit diagram of the server of FIG. 1;

FIG. 3 is a block diagram of a proximity controller in accordance with the present invention;

FIG. 4A-4C is a circuit diagram of the proximity controller of FIG. 3; and

FIG. 5 is a perspective view of the proximity controller of FIG. 3.

### DETAILED DESCRIPTION OF THE PREFERRED EMBODIMENT

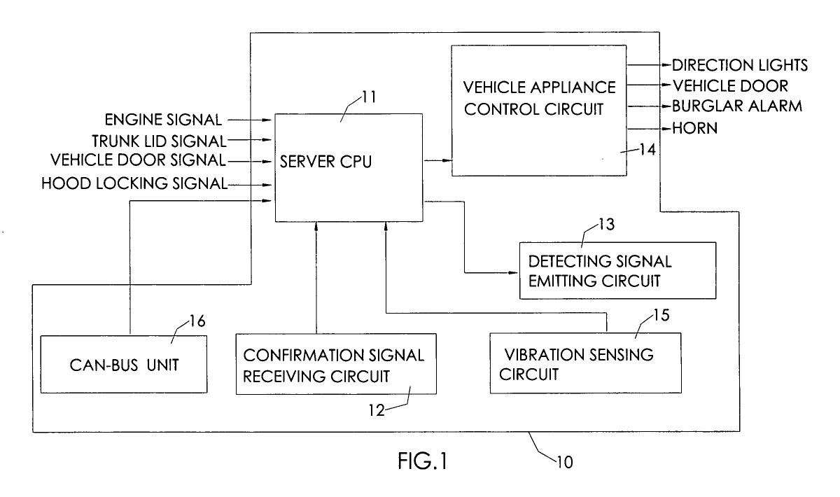

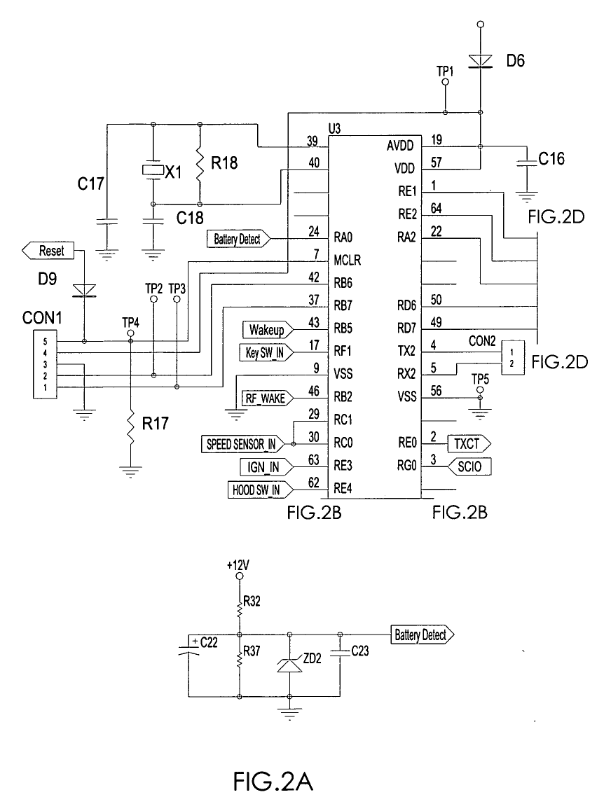

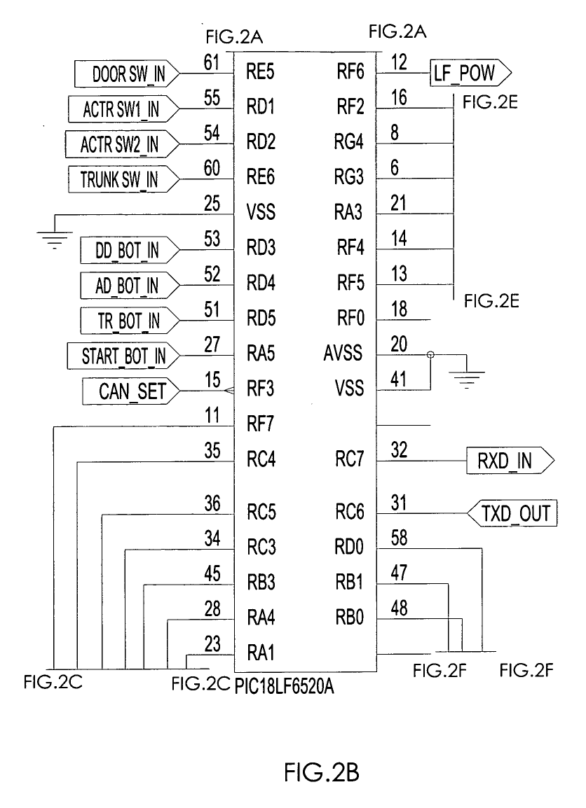

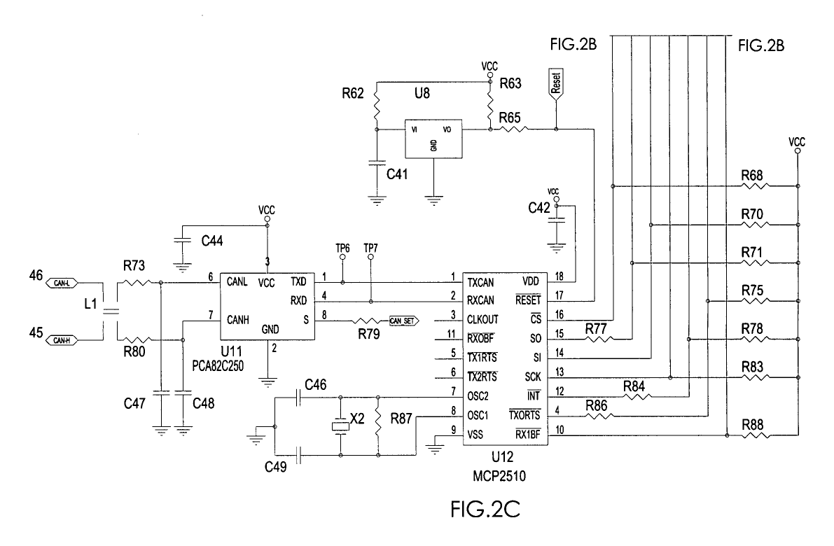

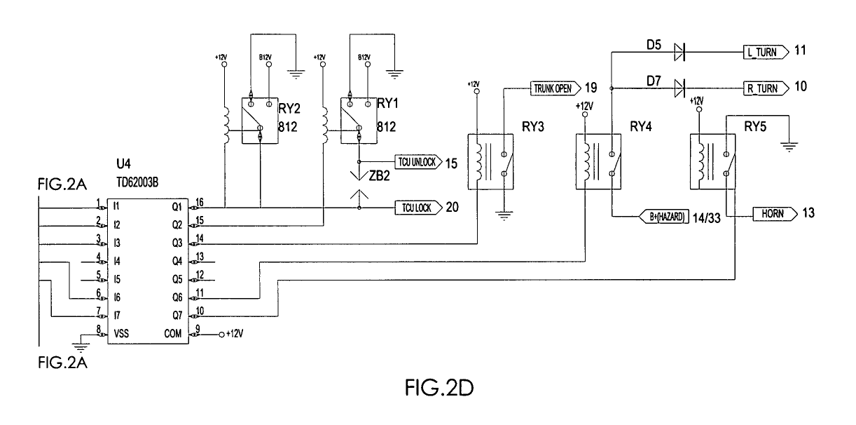

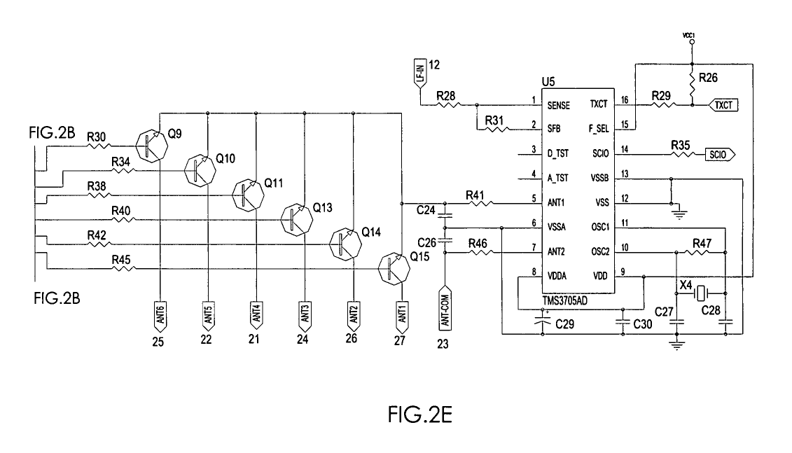

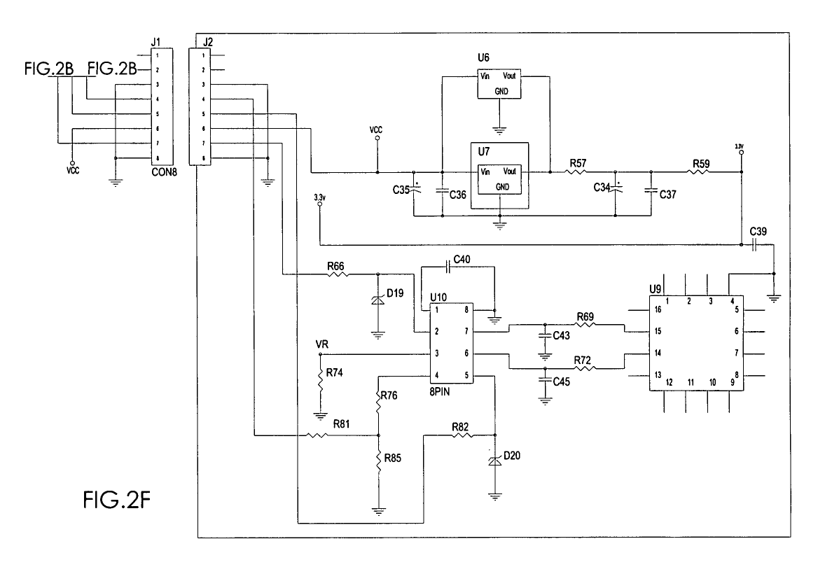

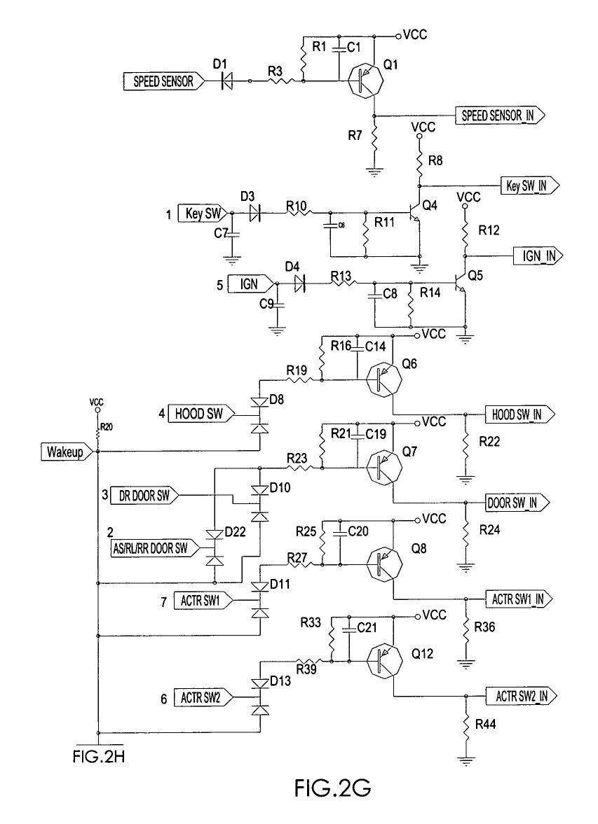

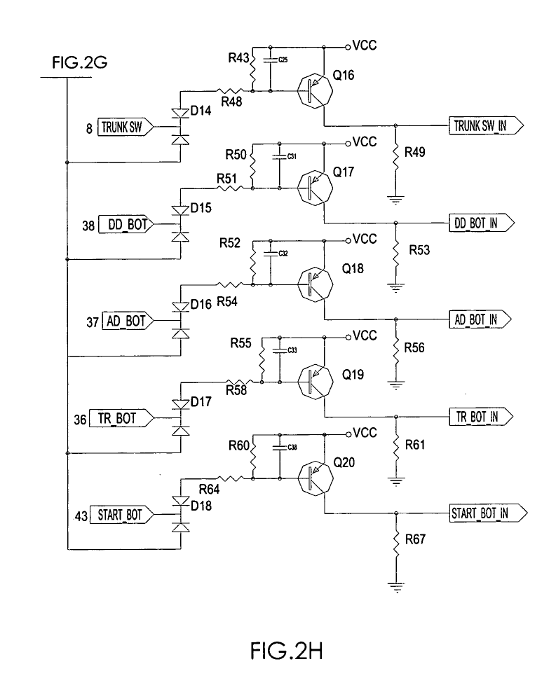

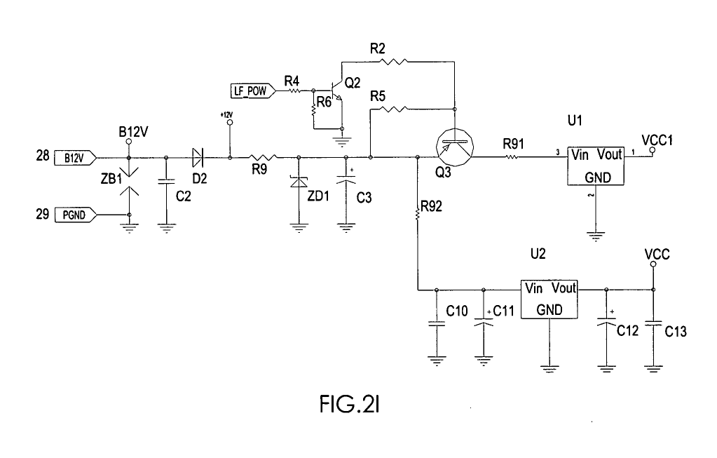

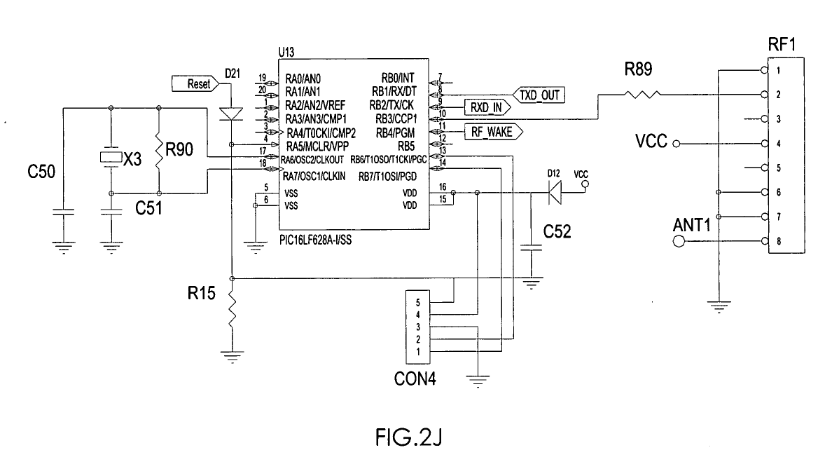

A sensitive remote lock control apparatus in accordance with the present invention comprises a server (10) mounted in a vehicle and a portable proximity controller (20). With reference to FIGS. 1 and 2A-2J, the server (10) includes a server CPU (central processing unit) (11), a confirmation signal receiving circuit (12), an detecting signal emitting circuit (13), a vehicle appliance control circuit (14), a vibration sensing circuit (15) and a CAN-bus (controller area network bus) unit (16). Input terminals of the server CPU (11) are connected to the confirmation signal receiving circuit (12), the vibration sensing circuit (15), the CAN-bus unit (16) and receive multiple different vehicle status signals such as an engine signal, a trunk lid locking signal, a vehicle door locking signal and a hood locking signal. Output terminals of the server CPU (11) are connected to the detecting emitting circuit (13) and the vehicle appliance control circuit (14). The vehicle appliance control circuit (14) is connected to direction lights, a vehicle door lock, a burglar alarm and a horn.

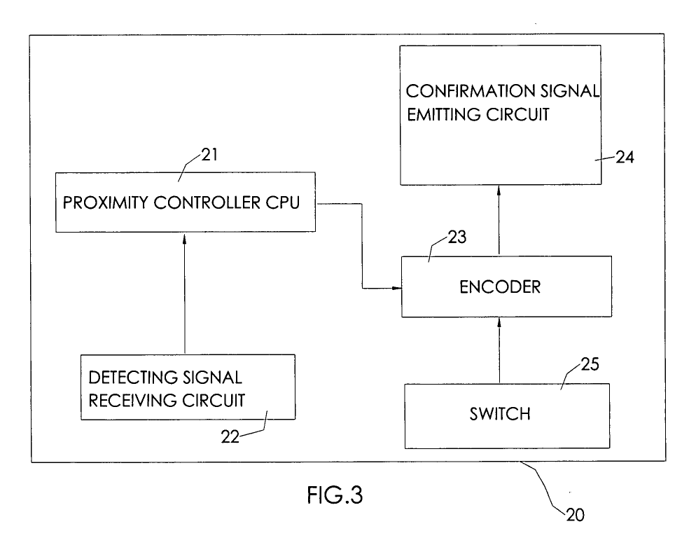

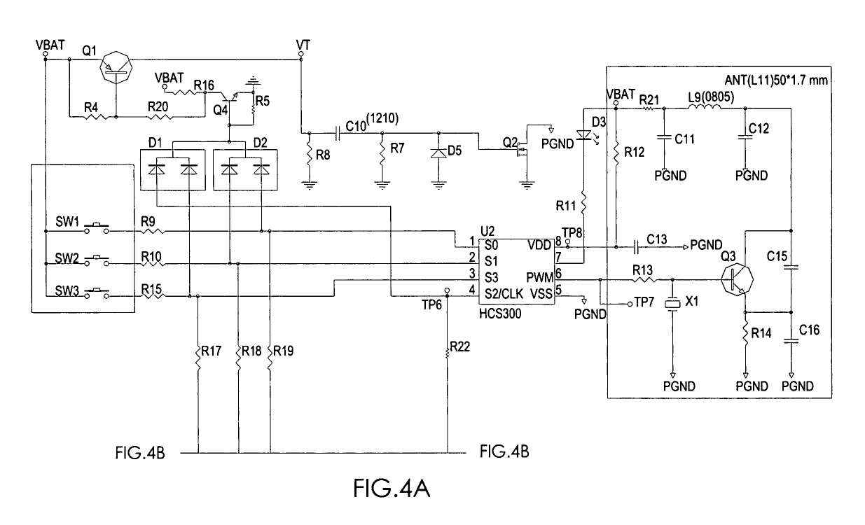

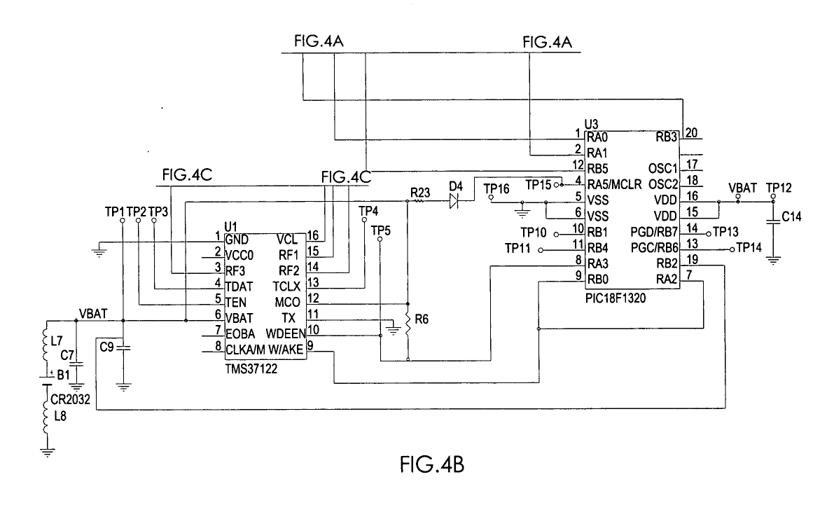

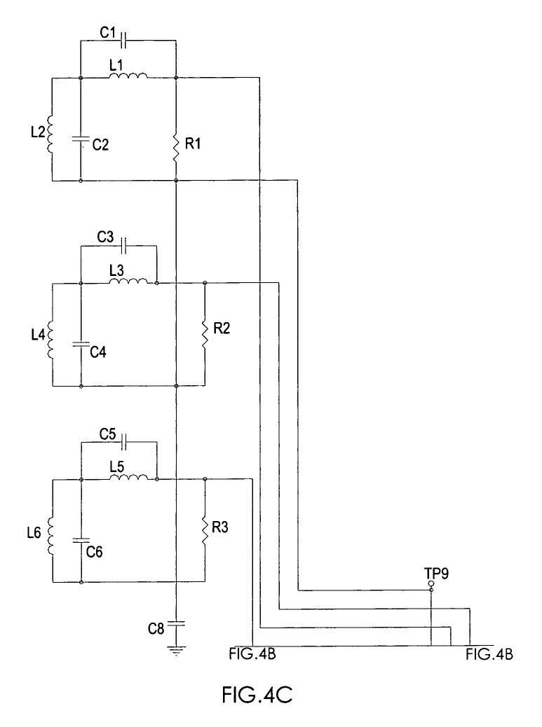

With reference to FIGS. 3 and 4A-4C, the portable proximity controller (20) comprises a proximity controller CPU (central processing unit) (21), a detecting signal receiving circuit (22), an encoder (23), a confirmation signal emitting circuit (24) and a switch (25).

When the driver turns the engine off, opens the vehicle door and further closes the vehicle door, the server CPU (11) determines that the vehicle door has closed and activates the detecting signal emitting circuit (13) to continuously radiate a modulated low-frequency detecting signal. If the driver leaves the vehicle and takes away the proximity controller (20), the server CPU (11) receives no confirmation signal output from the proximity controller (20) when the proximity controller (20) is out of an effective range of the server (10) within which the receiving circuit (12) can detects the confirmation signal of the proximity controller (20). The server (10) then checks whether or not the vehicle door has been locked. If the driver forgets to do so, the server (10) automatically locks the door through the vehicle appliance control circuit (14). Meanwhile, the server (10) also activates the vibration sensing circuit (15) to enable a vehicle security system. The detecting signal emitting circuit (13) still remains to continuously radiate the modulated low-frequency signal.

When the vibration sensing circuit (15) detects any shake of the vehicle, the server CPU (11) controls the vehicle appliance control circuit (14) to activate the burglar alarm, flash the direction lights and sound a car horn to make a noise.

Because the server (10) continuously radiates the low-frequency detecting signal, the proximity controller (20) can receive the detecting signal through the detecting signal receiving circuit (22) when the proximity controller (20) approaches the vehicle and within the effective range. After the proximity controller (20) confirms the received detecting signal, the proximity controller CPU (21) generates a signal and outputs the signal to the encoder (23). The signal is encoded to form a confirmation signal and then wirelessly output by the emitting circuit (24). When the confirmation signal is received by the receiving circuit (12) of the server (10), the server CPU (11) determines whether or not the received confirmation signal is correct. If the confirmation signal is correct, the server (10) then automatically unlocks the vehicle door and lifts the vehicle security system.

As long as the proximity controller (20) is within the effective range, the vehicle door remains in an unlocked status. Further, the detecting signal emitting circuits (13) stops to generate the detecting signal until the server (10) detects that the vehicle door is opened and subsequently closed.

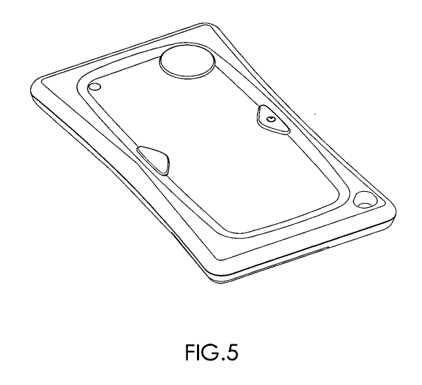

With reference to FIG. 5, an operating button (201) is mounted on the surface of the proximity controller (20). If a user purposely presses the button (201), the switch (25) can generate a signal to be encoded and transmitted through the encoder (23) and the transmitting circuit (24) as the confirmation signal to lock or unlock the vehicle door or the trunk lid.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A sensitive locking control device for a vehicle, the device comprising:
a server mounted in the vehicle, the server having
a server CPU to receive multiple vehicle status signals;
a confirmation signal receiving circuit connected to the server CPU;
a detecting signal emitting circuit connected to the server CPU to output a detecting signal; and
a vehicle appliance control circuit connected to the server CPU to control different appliances of the vehicle;
a portable proximity controller having
a proximity controller CPU;
a detecting signal receiving circuit connected to the proximity controller CPU to receive the detecting signal;
an encoder connected to the CPU; and
a confirmation signal emitting circuit connected to the encoder to output an confirmation signal;
the server continuously emitting the detecting signal until the proximity controller responds a correct confirmation signal to the server; when the server receives and checks the confirmation signal, the server controls the different appliances of the vehicle using the vehicle appliance control circuit.

2. The device as claimed in claim 1, wherein the server further has a vibration sensing circuit connected to the server CPU to detect whether or not the vehicle experiences any vibration.

3. The device as claimed in claim 1, wherein the server further has a CAN-Bus unit connected to the server CPU.

4. The device as claimed in claim 2, wherein the server further has a CAN-Bus unit connected to the server CPU.

5. The device as claimed in claim 1, the proximity controller having a switch connected to the confirmation signal emitting circuit through the encoder, wherein the confirmation signal is purposely generated by activating the switch.

6. The device as claimed in claim 4, the proximity controller having a switch connected to the confirmation signal emitting circuit through the encoder, wherein the confirmation signal is purposely generated by activating the switch.

7. The device as claimed in claim 6, the multiple vehicle signals received by the server CPU comprises an engine signal, a trunk lid locking signal, a vehicle door locking signal and a hood locking signal.

8. The device as claimed in claim 7, the appliances of the vehicle comprises direction lights, a vehicle door lock, a burglar alarm and a horn.
